(19) United States
(12) Patent Application Publication
(10) Pub. No.: US 2026/0340798 A1
(43) Pub. Date: Oct. 29, 2026

(54) METHOD AND APPARATUS FOR GENERATING IMAGE OF WEATHERED MARTIAN ROCK, ELECTRONIC DEVICE, AND STORAGE MEDIUM

(71) Applicant: WUHAN UNIVERSITY, Wuhan (CN)

(72) Inventors: Jiangmei QIAO, Wuhan (CN); Xuhai TANG, Wuhan (CN); Shengzong XU, Wuhan (CN); Yuwen TONG, Wuhan (CN)

(21) Appl. No.: 19/654,519

(22) Filed: Apr. 22, 2026

(30) Foreign Application Priority Data
Apr. 25, 2025 (CN) 202510534304.4

(51) Int. Cl. G06T 7/00; G06T 11/00; G06V 10/82; G06V 20/10

(52) U.S. Cl. CPC G06T 7/0002; G06T 11/00; G06V 10/82; G06V 20/10; G06T 2207/20084; G06T 2207/30168

(57) ABSTRACT

A method and apparatus for generating an image of a weathered Martian rock, an electronic device, and a storage medium are provided. The method includes: obtaining a weathered Martian rock sample; generating a Martian rock dataset based on the weathered Martian rock sample, and transferring knowledge of a predetermined CGAN model to the Martian rock dataset to obtain a transfer-optimized Martian rock dataset; and generating a weathered Martian rock microscopic image based on the transfer-optimized Martian rock dataset, comparing the weathered Martian rock microscopic image with the weathered Martian rock sample, and evaluating a generation quality of the weathered Martian rock microscopic image based on a comparison result.

### CROSS-REFERENCE TO RELATED APPLICATIONS

This application claims priority to Chinese Patent Application No. 202510534304.4, filed with the China National Intellectual Property Administration on Apr. 25, 2025 and entitled “METHOD AND APPARATUS FOR GENERATING IMAGE OF WEATHERED MARTIAN ROCK, ELECTRONIC DEVICE, AND STORAGE MEDIUM”, which is incorporated herein by reference in its entirety.

### FIELD

The present disclosure relates to the technical fields of digital rock core, Artificial Intelligence (AI), and numerical simulation, and more particularly, to a method and apparatus for generating an image of a weathered Martian rock, an electronic device, and a storage medium.

### BACKGROUND

A microstructure of Martian rocks directly affects their physical-mechanical properties, holding significant scientific value for understanding weathering on the Martian surface, a geological evolution process of Mars, and planetary resource assessment. However, due to limitations of Mars exploration missions, research on Martian rocks in the related art mainly focuses on mineral composition analysis, while systematic studies on their microstructure, physical-mechanical properties, and weathering mechanisms remains relatively scarce. The lack of microscopic image data restricts quantitative analyses of pore structures, fracture evolution, and mechanical properties of Martian rocks, which in turn affects data interpretation, landing site selection, and resource development strategies for Mars exploration missions. Conventional laboratory testing methods are difficult to apply directly due to extreme scarcity of Martian rock samples and constrained experimental conditions. In addition, analog studies based on terrestrial weathered rocks, although providing references, exhibit a significant limitation in characterizing a Martian rock property due to marked differences in environmental conditions between Earth and Mars, such as gravity, temperature, and atmospheric composition. Therefore, developing a method for generating a microscopic image of a Martian rock is crucial for Martian rock mechanics research.

In the related art, generative AI technologies such as generative adversarial networks, variational autoencoders, and diffusion models have achieved significant progress in terrestrial rock image generation, pore structure modeling, and rock physical parameter prediction.

However, research in the related art primarily relies on terrestrial rock samples for training. A generalization ability of models depends on large amounts of data. Given that Martian rock samples are extremely limited, existing AI models struggle to accurately reflect properties of weathered Martian rocks under data-scarce conditions, which urgently needs to be resolved.

### SUMMARY

The present disclosure provides a method and apparatus for generating an image of a weathered Martian rock, an electronic device, and a storage medium, to solve problems in the related art such as a significant limitation in characterizing a Martian rock property, and provide technical support for landing site selection, drilling strategy formulation, and in-situ resource utilization for Mars probes.

According to an embodiment in a first aspect of the present disclosure, a method for generating an image of a weathered Martian rock is provided. The method includes: obtaining a weathered Martian rock sample; generating a Martian rock dataset based on the weathered Martian rock sample, and transferring knowledge of a predetermined Conditional Generative Adversarial Network (CGAN) model to the Martian rock dataset to obtain a transfer-optimized Martian rock dataset; and generating a weathered Martian rock microscopic image based on the transfer-optimized Martian rock dataset, comparing the weathered Martian rock microscopic image with the weathered Martian rock sample, and evaluating a generation quality of the weathered Martian rock microscopic image based on a comparison result.

In an embodiment, the method further includes, prior to the obtaining the weathered Martian rock sample: obtaining a plurality of types of terrestrial rock samples; performing a micro-scale test and a macro-scale test on the plurality of types of terrestrial rock samples to obtain a micro-parameter and a macro-parameter of the plurality of types of terrestrial rock samples, respectively, and performing a standardization processing on the micro-parameter and the macro-parameter to obtain a processed micro-parameter and a processed macro-parameter; and establishing a multi-scale database of terrestrial weathered rocks based on the processed micro-parameter and a macro-physical-mechanical parameter.

In an embodiment, the method further includes, prior to the obtaining the weathered Martian rock sample: generating a plurality of rock feature labels for the plurality of types of terrestrial rock samples based on the plurality of types of terrestrial rock samples, where the plurality of rock feature labels include a mineral composition label, a weathering degree label, and a micro-structural feature label; and constructing a predetermined CGAN model based on a conditional generative adversarial network and the plurality of rock feature labels.

In an embodiment, the predetermined CGAN model includes a CGAN model generator and a CGAN model discriminator. The CGAN model generator is obtained based on a random vector and the weathering degree label, and is configured to generate a rock mineral crystal model based on the random vector, the plurality of rock feature labels, and a predetermined loss function. The CGAN model discriminator is obtained based on the rock mineral crystal model and the weathering degree label, and is configured to discriminate an image generated by the rock mineral crystal model.

In an embodiment, the predetermined loss function is: [symbol]
where L_{adv} represents an adversarial loss of the CGAN, λ₁ represents a weight hyperparameter for a mineral composition loss, L_{mineral-comp} represents the mineral composition loss, λ₂ represents a weight hyperparameter for a mineral morphology loss, Lₘᵢₙₑᵣₐₗ₋ₛₕₐₚ represents the mineral morphology loss, λ₃ represents a weight hyperparameter for a weathering degree loss, L_{weathering-prod} represents the weathering degree loss, λ₄ represents a weight hyperparameter for a porosity ratio loss, L_{porosity} represents the porosity ratio loss, λ₅ represents a weight hyperparameter for a structural similarity loss, and L_{SSIM} represents the structural similarity loss.

In an embodiment, the comparison result includes structural similarity, perceptual loss, peak signal-to-noise ratio, and Frechet Inception Distance. The evaluating the generation quality of the weathered Martian rock microscopic image based on the comparison result includes: comparing each of the structural similarity, the perceptual loss, the peak signal-to-noise ratio, and the Frechet Inception Distance with a corresponding threshold based on a predetermined quantitative evaluation method, to obtain a plurality of comparison results; and verifying, based on the plurality of comparison results, whether the weathered Martian rock microscopic image meets a predetermined validity condition, and evaluating the generation quality of the weathered Martian rock microscopic image based on a verification result.

According to an embodiment in a second aspect of the present disclosure, an apparatus for generating an image of a weathered Martian rock is provided. The apparatus includes: an obtaining module configured to obtain a weathered Martian rock sample; a transfer module configured to generate a Martian rock dataset based on the weathered Martian rock sample, and transfer knowledge of a predetermined CGAN model to the Martian rock dataset to obtain a transfer-optimized Martian rock dataset; and a generation module configured to generate a weathered Martian rock microscopic image based on the transfer-optimized Martian rock dataset, compare the weathered Martian rock microscopic image with the weathered Martian rock sample, and evaluate a generation quality of the weathered Martian rock microscopic image based on a comparison result.

In an embodiment, the obtaining module is further configured to, prior to obtaining the weathered Martian rock sample: obtain a plurality of types of terrestrial rock samples; perform a micro-scale test and a macro-scale test on the plurality of types of terrestrial rock samples to obtain a micro-parameter and a macro-parameter of the plurality of types of terrestrial rock samples, respectively, and perform a standardization processing on the micro-parameter and the macro-parameter to obtain a processed micro-parameter and a processed macro-parameter; and establish a multi-scale database of terrestrial weathered rocks based on the processed micro-parameter and a macro-physical-mechanical parameter.

In an embodiment, the obtaining module is further configured to, prior to obtaining the weathered Martian rock sample: generate a plurality of rock feature labels for the plurality of types of terrestrial rock samples based on the plurality of types of terrestrial rock samples, where the plurality of rock feature labels include a mineral composition label, a weathering degree label, and a micro-structural feature label; and construct a predetermined CGAN model based on a conditional generative adversarial network and the plurality of rock feature labels.

In an embodiment, the predetermined CGAN model includes a CGAN model generator and a CGAN model discriminator. The CGAN model generator is obtained based on a random vector and the weathering degree label, and is configured to generate a rock mineral crystal model based on the random vector, the plurality of rock feature labels, and a predetermined loss function. The CGAN model discriminator is obtained based on the rock mineral crystal model and the weathering degree label, and is configured to discriminate an image generated by the rock mineral crystal model.

In an embodiment, the predetermined loss function is: [symbol]
where L_{adv} represents an adversarial loss of the CGAN, λ₁ represents a weight hyperparameter for a mineral composition loss, L_{mineral-comp} represents the mineral composition loss, λ₂ represents a weight hyperparameter for a mineral morphology loss, Lₘᵢₙₑᵣₐₗ₋ₛₕₐₚ represents the mineral morphology loss, λ₃ represents a weight hyperparameter for a weathering degree loss, L_{weathering-prod} represents the weathering degree loss, λ₄ represents a weight hyperparameter for a porosity ratio loss, L_{porosity} represents the porosity ratio loss, λ₅ represents a weight hyperparameter for a structural similarity loss, and L_{SSIM} represents the structural similarity loss.

In an embodiment, the comparison result includes structural similarity, perceptual loss, peak signal-to-noise ratio, and Frechet Inception Distance. The generation module is specifically configured to: compare each of the structural similarity, the perceptual loss, the peak signal-to-noise ratio, and the Frechet Inception Distance with a corresponding threshold based on a predetermined quantitative evaluation method, to obtain a plurality of comparison results; and verify, based on the plurality of comparison results, whether the weathered Martian rock microscopic image meets a predetermined validity condition, and evaluate the generation quality of the weathered Martian rock microscopic image based on a verification result.

According to an embodiment in a third aspect of the present disclosure, an electronic device is provided. The electronic device includes at least one processor and a memory communicatively connected to the at least one processor. The memory stores instructions executable by the at least one processor. The instructions are configured to perform the method for generating the image of the weathered Martian rock according to any of the above embodiments.

According to an embodiment in a fourth aspect of the present disclosure, a computer-readable storage medium is provided. The computer-readable storage medium stores a computer program. The computer program is executed by a processor to implement the method for generating the image of the weathered Martian rock according to any of the above embodiments.

Thus, according to the embodiments of the present disclosure, the weathered Martian rock sample is obtained. The Martian rock dataset is generated. The knowledge of the predetermined CGAN model is transferred to the Martian rock dataset to obtain the transfer-optimized Martian rock dataset. The weathered Martian rock microscopic image is generated, and compared with the weathered Martian rock sample. The generation quality of the weathered Martian rock microscopic image is evaluated based on the comparison result. Thus, through transfer learning from a terrestrial weathered rock database, the conditional generative adversarial network is constructed to generate the weathered Martian rock microscopic image, which solves the problems in the related art such as the significant limitation in characterizing the Martian rock property, and provides the technical support for the landing site selection, the drilling strategy formulation, and the in-situ resource utilization for the Mars probes.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a flowchart of a method for generating an image of a weathered Martian rock according to an embodiment of the present disclosure.

FIG. 2 is a schematic diagram of small sample data of a Martian meteorite for a method for generating an image of a weathered Martian rock according to an embodiment of the present disclosure.

FIG. 3 is a schematic diagram of a CGAN model construction framework for a method for generating an image of a weathered Martian rock according to an embodiment of the present disclosure.

FIG. 4 is a schematic diagram of a knowledge transfer strategy for a method for generating an image of a weathered Martian rock according to an embodiment of the present disclosure.

FIG. 5 is a flowchart of a method for generating an image of a weathered Martian rock according to an embodiment of the present disclosure.

FIG. 6 is a schematic diagram of an apparatus for generating an image of a weathered Martian rock according to an embodiment of the present disclosure.

FIG. 7 is a schematic structural diagram of an electronic device according to an embodiment of the present disclosure.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

A method and apparatus for generating an image of a weathered Martian rock, an electronic device, and a storage medium according to the embodiments of the present disclosure are described below with reference to the accompanying drawings. In response to the problem mentioned in the above background technology that there is the significant limitation in characterizing the Martian rock property, the present disclosure provides a method for generating an image of a weathered Martian rock. In this method, according to the embodiments of the present disclosure, a weathered Martian rock sample is obtained, a Martian rock dataset is generated, knowledge of a predetermined CGAN model is transferred to the Martian rock dataset to obtain a transfer-optimized Martian rock dataset, a weathered Martian rock microscopic image is generated and compared with the weathered Martian rock sample, and a generation quality of the weathered Martian rock microscopic image is evaluated based on a comparison result. Thus, through transfer learning from a terrestrial weathered rock database, a conditional generative adversarial network is constructed to generate the weathered Martian rock microscopic image, which solves problems in the related art such as the significant limitation in characterizing the Martian rock property, and provides technical support for landing site selection, drilling strategy formulation, and in-situ resource utilization for Mars probes.

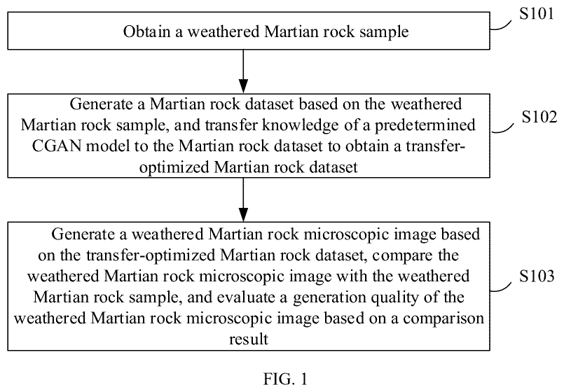

In an embodiment, FIG. 1 is a schematic flowchart of a method for generating an image of a weathered Martian rock according to an embodiment of the present disclosure.

As illustrated in FIG. 1, the method for generating the image of the weathered Martian rock includes following steps S101 to S103.

At step S101, a weathered Martian rock sample is obtained.

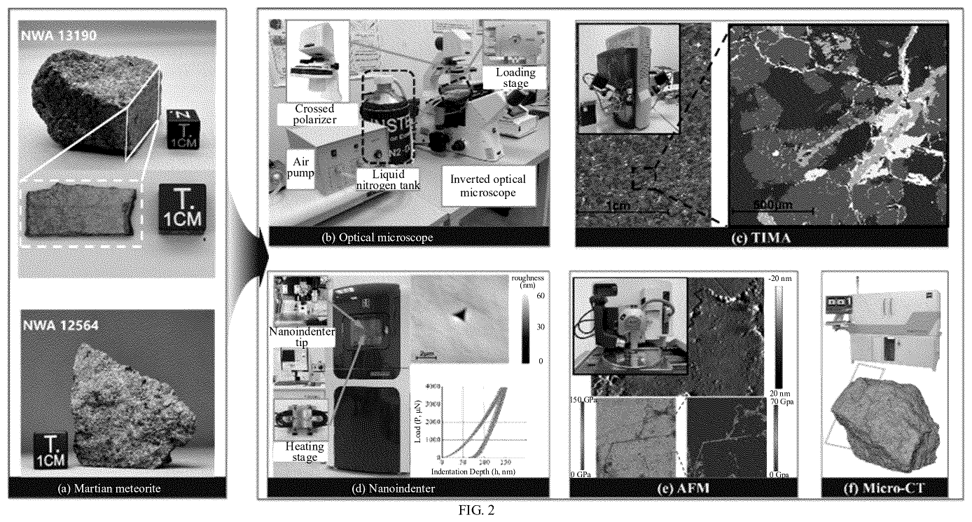

FIG. 2 is a schematic diagram of small sample data of a Martian meteorite for a method for generating an image of a weathered Martian rock according to an embodiment of the present disclosure. As illustrated in FIG. 2, main rock-forming mineral compositions of the Martian meteorite are determined based on a test using a Tescan Integrated Mineral Analyzer (TIMA). Load-displacement curves of the main rock-forming minerals are obtained separately based on nanoindentation. Elastic moduli and hardness of the main rock-forming minerals are calculated based on the load-displacement curves. Surface roughness and elastic moduli of intergranular phases of different mineral crystals are obtained based on an atomic force microscope. A three-dimensional mineral and micro-pore distribution of the Martian meteorite is obtained based on Computed Tomography (CT) scanning technology.

In some embodiments, the method further includes, prior to obtaining the weathered Martian rock sample: obtaining a plurality of types of terrestrial rock samples; performing a micro-scale test and a macro-scale test on the plurality of types of terrestrial rock samples to obtain a micro-parameter and a macro-parameter of the plurality of types of terrestrial rock samples, and performing a standardization processing on the micro-parameter and the macro-parameter to obtain a processed micro-parameter and a processed macro-parameter; and establishing a multi-scale database of terrestrial weathered rocks based on the processed micro-parameter and the processed macro-parameter.

It should be understood that terrestrial rock samples of different weathering degrees and rock types are obtained to perform the micro-scale test and the macro-scale test. At the micro-scale, micro-parameters such as mineral composition, microstructure, rock-forming minerals, and mechanical property of intergranular phases of the terrestrial rock samples are obtained through micro-rock experiments. At the macro-scale, macro-physical-mechanical parameters such as elastic modulus, hardness, compressive strength, tensile strength, fracture toughness, and wave velocity of terrestrial rock samples with different weathering degrees are obtained through macro-experiments such as uniaxial compression, Brazilian splitting, and wave velocity testing. The multi-scale database of terrestrial weathered rocks is established based on a data standardization processing. The data standardization processing is performed using image enhancement and feature extraction methods (such as edge detection, Fourier transform, and morphological analysis). In this way, the quality of training data is improved, noise influence is reduced, and data support is provided for subsequent weathering geological knowledge extraction, feature label construction, and AI model development.

In some embodiments, the method further includes, prior to the operation of obtaining the weathered Martian rock sample: generating a plurality of rock feature labels for the plurality of types of terrestrial rock samples based on the plurality of types of terrestrial rock samples, where the plurality of rock feature labels include a mineral composition label, a weathering degree label, and a micro-structural feature label; and constructing a predetermined CGAN model based on a conditional generative adversarial network and the plurality of rock feature labels.

It should be understood that, based on multi-scale weathering research, weathering primarily exerts a significant influence on the mineral composition, distribution, and micro-pore characteristics of rocks. Extracted rock features include the mineral composition i.e., main mineral components in rock samples. A mechanical parameter of a mineral crystal is obtained through a nanoindentation test. Minerals are classified as weathering-resistant and weathering-susceptible. The mineral composition label is obtained by quantitatively analyzing the mineral composition of the rock samples (including a weathering-resistant mineral, a weathering-susceptible mineral, and a weathering product) through techniques such as X-ray diffraction and scanning electron microscopy, obtaining a volume fraction and a mass fraction of the mineral composition; extracting rock features including the weathering product, that is, determining the weathering product (such as kaolinite and hematite) formed during weathering, and analyzing formation and a distribution pattern of the weathering product at different stages of weathering. The weathering degree label is marked based on the weathering grade standards of the International Society for Rock Mechanics. The weathering degree of each rock sample is annotated to ensure a correspondence between selected weathering features and physical-mechanical features of the rocks. The rock features extracted include the microstructure. That is, evolution of the microstructure such as mineral distribution, mineral morphology, and micropores during the weathering is recorded. The micro-structural feature label is derived from a microstructural feature, such as porosity and fracture density, extracted via CT scanning technology. In addition, an orientation distribution of mineral crystals is analyzed through microscopic techniques such as electron backscatter diffraction, serving as an “orientation degree” label to describe an alignment and orientation feature of a mineral in the rock. In addition, a structural similarity index is introduced to measure similarity of local details of rock mineral crystals. The rock feature label with a real physical attribute is constructed based on an extraction of weathering geological knowledge. A network parameter is initialized based on the rock feature label. Real samples and labels are input. Fake samples G(z|y) are generated. A discriminator parameter is updated. A generator parameter is updated. The predetermined CGAN model is constructed based on the conditional generative adversarial network.

In some embodiments, the predetermined CGAN model includes a CGAN model generator and a CGAN model discriminator. The CGAN model generator is obtained based on a random vector and the weathering degree label, and is configured to generate a rock mineral crystal model based on the random vector, the plurality of rock feature labels, and a predetermined loss function. The CGAN model discriminator of the predetermined CGAN model is obtained based on the rock mineral crystal model and the weathering degree label, and is configured to discriminate an image generated by the rock mineral crystal model.

In some embodiments, the predetermined loss function is: [symbol]
where L_{adv} represents an adversarial loss of the CGAN, λ₁ represents a weight hyperparameter for a mineral composition loss, L_{mineral-comp} represents the mineral composition loss, λ₂ represents a weight hyperparameter for a mineral morphology loss, Lₘᵢₙₑᵣₐₗ₋ₛₕₐₚ represents the mineral morphology loss, λ₃ represents a weight hyperparameter for a weathering degree loss, L_{weathering-prod} represents the weathering degree loss, λ₄ represents a weight hyperparameter for a porosity ratio loss, L_{porosity} represents the porosity ratio loss, λ₅ represents a weight hyperparameter for a structural similarity loss, and L_{SSIM} represents the structural similarity loss.

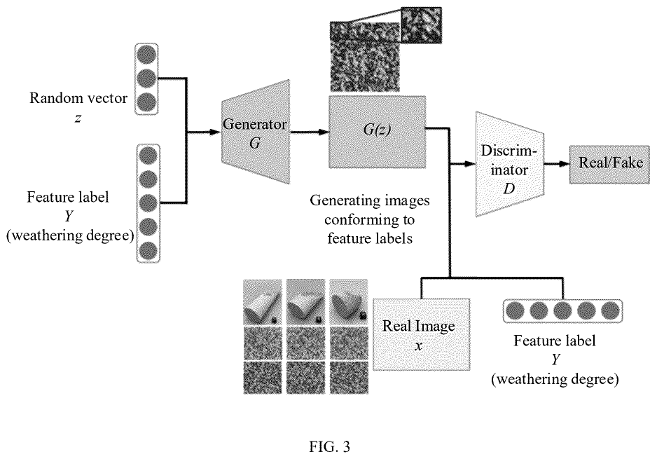

FIG. 3 is a schematic diagram of a CGAN model construction framework for a method for generating an image of a weathered Martian rock according to an embodiment of the present disclosure. It should be understood that, as illustrated in FIG. 3, a Conditional Generative Adversarial Network (CGAN) structure is adopted according to the embodiment of the present disclosure. An input of a generator G is random noise and the weathering degree label. Conditional information is introduced into a generation network through a concatenation vector injection mechanism. A predetermined loss function is integrated to generate corresponding mineral crystal images under the weathering stage. The input of the generator includes the weathering degree label (wj):x′i=G (z, wj), where G represents the generator, and x′i represents a generated weathered rock mineral crystal model. The generator is configured to generate a rock mineral crystal model with a physical attribute and a structure that are consistent with an input feature label based on these conditional labels and random noise z. The discriminator D is configured to receive a real sample or a generated image and a corresponding label thereof, and adopt a PatchGAN architecture to discriminate local regions of the image to improve detail fidelity. The mineral composition label and the micro-structural feature label participate in loss function calculation. The loss function includes adversarial loss, mineral composition loss, orientation degree loss, weathering product and pore ratio loss, and Structural Similarity Index (SSIM) loss, to generate a mineral crystal model with consistent physical attributes. An input of the discriminator is composed of the generated rock sample and the real sample xᵢ, supplemented by the conditional label wⱼ, which can be expressed as D(xᵢ, wⱼ).

Further, L_{adv} represents the adversarial loss of the CGAN. A calculation formula for L_{adv} is:

L_{adv}=− [symbol] _{~p}_{_{data}}[logD(x|y)]− [symbol] _{~p}_{_{z}}[log(1−D(G(z|y)))]
where represents the adversarial loss of the CGAN, [symbol] _{~p}_{_{data}} represents an expectation over a real data distribution p_{data} , logD(x|y) represents a predicted logarithmic probability of the discriminator D for discriminating the input sample x as the real sample under a given condition y, [symbol] _{~p}_{_{z}} represents an expectation over a noise distribution p_{z}, and D(G(z|y)) represents a probability output of the discriminator D for discriminating, under the given condition y, the sample G(z|y) generated by the generator G as the real sample.

L_{mineral-comp} represents the mineral composition loss, ensuring that the mineral composition of the generated rock conforms to laws of weathering. A calculation formula for is:

L_{mineral-comp}=Σᵢ|\hat{M}ᵢ−mᵢ|
where \hat{M}ᵢ represents a predicted volume fraction of an i-th type of mineral in the generated image, and Mᵢ represents a volume fraction of the i-th type of mineral in a real geological sample.

Lₘᵢₙₑᵣₐₗ₋ₛₕₐₚ represents the mineral morphology loss, which uses an angular variance and cosine similarity to measure a difference in orientation degree between a generated mineral crystal and the real sample. A calculation formula for Lₘᵢₙₑᵣₐₗ₋ₛₕₐₚ is:

Lₘᵢₙₑᵣₐₗ₋ₛₕₐₚₑ=Σᵢ|Ôᵢ−Oᵢ|+λ_{θ}V_{ƒ}−λ_{cos}S_{cos}

Oᵢ where represents an orientation distribution of the generated mineral crystal, λ_{θ}and λ_{cos} represent hyperparameters and are used to adjust weights, V_{θ}represents a variance controlling the orientation, S_{cos} and represents similarity controlling the orientation.

In an embodiment, to ensure that a rock mineral structure generated by a weathered rock AI model conforms to reality in both overall distribution and local details, L_{SSIM} is introduced into the loss function to control local details (such as mineral crystal boundaries) of the generated rock mineral crystal graphics. The predetermined loss function of the generator and the discriminator includes two parts: adversarial loss and physical property loss.

At step S102, a Martian rock dataset is generated based on the weathered Martian rock sample, and knowledge of a predetermined CGAN model is transferred to the Martian rock dataset to obtain a transfer-optimized Martian rock dataset.

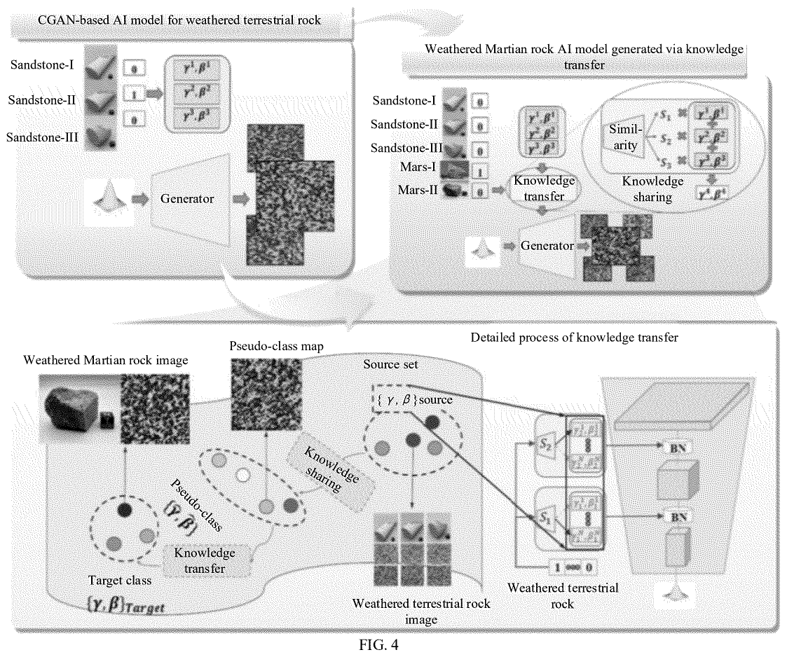

In an embodiment, based on the weathered Martian rock sample and in combination with the data standardization processing, a small data constraint for the Martian meteorite includes an introduction of micro-data and macro-data of the Martian meteorite, including mineral composition, microstructure, mineral crystals, and mechanical property of intergranular phases. FIG. 4 is a schematic diagram of a knowledge transfer strategy for a method for generating an image of a weathered Martian rock according to an embodiment of the present disclosure. As illustrated in FIG. 4, through transfer learning, weathering knowledge learned by a source domain Generative Adversarial Network (GAN) is applied to a target domain (the weathered Martian rock sample). Thus, an image of the weathered Martian rock with the real physical attribute is generated under a condition of extremely few Martian rock image data. Based on a knowledge transfer mechanism, through transfer of conditional Batch Normalization (BN) layer parameters, the weathering feature of the source domain (the terrestrial rock sample) is effectively transferred to the target domain (the weathered Martian rock sample) to solve a problem of scarcity of Martian data. Based on a knowledge sharing strategy, statistical features are shared among small-sample categories of Martian rocks to improve a generalization ability of the model under a small data volume. A regularization constraint for similarity and residuals is introduced into a training objective of the GAN to prevent overfitting and ensure stability and diversity of a generated result.

At step S103, a weathered Martian rock microscopic image is generated based on the transfer-optimized Martian rock dataset, the weathered Martian rock microscopic image is compared with the weathered Martian rock sample, and a generation quality of the weathered Martian rock microscopic image is evaluated based on a comparison result.

In an embodiment, the knowledge-transfer-optimized CGAN model is used to generate the weathered Martian rock microscopic image. The weathered Martian rock microscopic image is compared with an actual Martian meteorite sample to verify physical validity and detail fidelity of the generated image.

In some embodiments, the comparison result includes structural similarity, perceptual loss, peak signal-to-noise ratio, and Frechet Inception Distance. Evaluating the generation quality of the weathered Martian rock microscopic image based on the comparison result includes: comparing each of the structural similarity, the perceptual loss, the peak signal-to-noise ratio, and the Frechet Inception Distance with a corresponding threshold based on a predetermined quantitative evaluation method, to obtain a plurality of comparison results; and verifying, based on the plurality of comparison results, whether the weathered Martian rock microscopic image meets a predetermined validity condition, and evaluating the generation quality of the weathered Martian rock microscopic image based on a verification result.

It should be understood that, during comparison between the generated image and a real image, the following quantitative indicators are used to evaluate model performance. When a mean value of a Structural Similarity Index Measure (SSIM) reaches 0.87, the image structure is consistent. When a mean value of Learned Perceptual Image Patch Similarity (LPIPS) is lower than 0.12, the model has a satisfactory detail restoration ability. When a mean value of a Peak Signal-to-Noise Ratio (PSNR) is higher than 30 dB, the generated image has a high visual quality compared with the original image, with less noise and satisfactory image clarity. When a mean value of a Frechet Inception Distance (FID) is lower than 25, a distribution difference between the generated image and the real image is small, and the generated image is close to the real image in terms of visual quality.

Thus, according to the embodiments of the present disclosure, to address problems such as extreme scarcity of Martian rock samples, limitations of conventional experimental methods, and insufficient generalization ability of existing AI models, the multi-scale database of terrestrial weathered rocks is used to construct a Generative Adversarial Network model through transfer learning, enabling the Generative Adversarial Network model to effectively learn the microstructural feature of the Martian rock under the condition of small sample data of the Martian meteorite, generating the weathered Martian rock microscopic image with a real physical meaning. The embodiments of the present disclosure can be used for numerical simulation of the weathered Martian rock, prediction of physical-mechanical performance, and data support for deep space exploration missions, providing the technical support for the landing site selection, the drilling strategy formulation, and the in-situ resource utilization for the Mars probes.

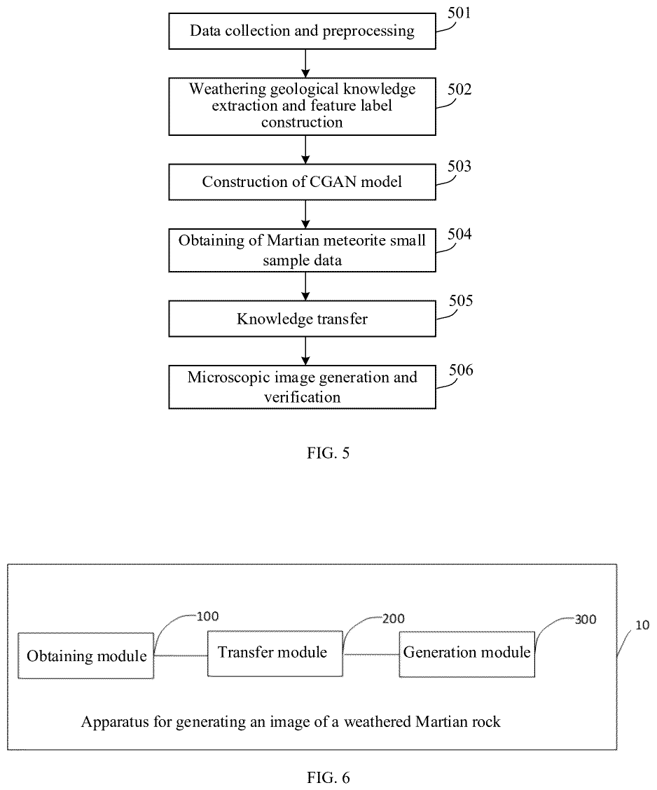

To facilitate further understanding by those skilled in the art of the method for generating the image of the weathered Martian rock according to the embodiments of the present disclosure, a detailed description is provided below in conjunction with the embodiment illustrated in FIG. 5.

FIG. 5 is a flowchart of a method for generating an image of a weathered Martian rock according to an embodiment of the present disclosure. As illustrated in FIG. 5, to address problems of extreme scarcity of Martian samples and difficulty of generalizing conventional experimental methods and AI models, the conditional generative adversarial network (CGAN) is constructed using the terrestrial weathered rock database, and weathering labels such as mineral composition, weathering product, and microstructure are extracted according to the embodiment of the present disclosure. Through the transfer learning, terrestrial weathering knowledge is transferred to the target domain of the Martian rock, achieving physically credible generation of microscopic images under a condition of a small amount of Martian meteorite data. An introduction of a multi-label physical constraint and a regularization mechanism significantly improves structural fidelity and weathering evolution consistency of the model in a small-sample environment. The embodiment of the present disclosure is applicable to scenarios such as structure prediction of the weathered Martian rock, landing site analysis, and image completion and auxiliary interpretation for deep space exploration missions, and has an advantage of efficient modeling under data-scarce conditions. The method for generating the image of the weathered Martian rock includes the following steps S501 to S506.

At step S501, data collection and preprocessing are performed, where the terrestrial rock sample is collected, a micro test and a macro test are performed, and a standardized multi-scale database is established.

At step S502, the mineral composition, the weathering product, and the microstructure of the terrestrial rock sample are extracted to construct a physical attribute label.

At step S503, the CGAN model is constructed, where feature labels are used as conditional inputs, the generator and the discriminator are designed, and a multi-constraint loss function is defined.

At step S504, research is conducted based on Martian meteorites NWA 13190 and NWA 12564, and small data on minerals, mechanics, and pores of the Martian meteorite 13190 is obtained from the Martian meteorite sample through techniques such as TIMA, nanoindentation, and CT scanning.

At step S505, knowledge is transferred through applying conditional batch normalization and feature sharing to a parameter of a terrestrial rock CGAN model, with regularization introduced to prevent overfitting, and weathering knowledge learned by a source domain CGAN model is applied to the target domain (the Martian meteorite 13190) through transfer learning.

At step S506, under a condition of image data of the Martian meteorite 13190, an image of the weathered Martian meteorite 13190 with a real physical attribute is generated, and quantitative verification is performed through indicators such as SSIM and PSNR to ensure physical validity and detail fidelity.

Thus, according to the embodiment of the present disclosure, a data bottleneck is broken through. Through the transfer learning and the small-data constraint, the GAN model can still generate a high-quality microscopic image under a condition of limited Martian rock samples. In combination with a physical constraint and weathering simulation, rationality of a mineral structure of the generated image is improved, providing the generated image higher physical credibility and enhancing image authenticity. By combining a generative AI algorithm with rock physics modeling, a multi-scale weathered Martian rock database is constructed, providing data support for numerical simulation and exploration missions and supporting multi-scale analysis. The embodiment of the present disclosure can be used for Martian landing site selection, drilling analysis, and resource assessment, improving scientific efficiency and engineering feasibility of exploration missions, and enhancing Martian exploration applications.

With the method for generating the image of the weathered Martian rock according to the embodiments of the present disclosure, the weathered Martian rock sample is obtained. The Martian rock dataset is generated. The knowledge of the predetermined CGAN model is transferred to the Martian rock dataset to obtain the transfer-optimized Martian rock dataset. The weathered Martian rock microscopic image is generated, and compared with the weathered Martian rock sample. The generation quality of the weathered Martian rock microscopic image is evaluated based on the comparison result. Thus, through transfer learning from the terrestrial weathered rock database, the conditional generative adversarial network is constructed to generate the weathered Martian rock microscopic image, which solves the problems in the related art such as the significant limitation in characterizing the Martian rock property, and provides the technical support for the landing site selection, the drilling strategy formulation, and the in-situ resource utilization for the Mars probes.

An apparatus for generating an image of a weathered Martian rock according to an embodiment of the present disclosure is described below with reference to the accompanying drawings.

FIG. 6 is a block diagram of an apparatus for generating an image of a weathered Martian rock according to an embodiment of the present disclosure.

As illustrated in FIG. 6, an apparatus 10 for generating an image of a weathered Martian rock includes an obtaining module 100, a transfer module 200, and a generation module 300.

The obtaining module 100 is configured to obtain a weathered Martian rock sample.

The transfer module 200 is configured to generate a Martian rock dataset based on the weathered Martian rock sample, and transfer knowledge of a predetermined CGAN model to the Martian rock dataset to obtain a transfer-optimized Martian rock dataset.

The generation module 300 is configured to generate a weathered Martian rock microscopic image based on the transfer-optimized Martian rock dataset, compare the weathered Martian rock microscopic image with the weathered Martian rock sample, and evaluate a generation quality of the weathered Martian rock microscopic image based on a comparison result.

In some embodiments, the obtaining module 100 is further configured to, prior to obtaining the weathered Martian rock sample: obtain a plurality of types of terrestrial rock samples; perform a micro-scale test and a macro-scale test on the plurality of types of terrestrial rock samples to obtain a micro-parameter and a macro-parameter of the plurality of types of terrestrial rock samples, and perform a standardization processing on the micro-parameter and the macro-parameter to obtain a processed micro-parameter and a processed macro-parameter; and establish a multi-scale database of terrestrial weathered rocks based on the processed micro-parameter and a macro-physical-mechanical parameter.

In some embodiments, the obtaining module 100 is further configured to, prior to obtaining the weathered Martian rock sample: generate a plurality of rock feature labels for the plurality of types of terrestrial rock samples based on the plurality of types of terrestrial rock samples, where the plurality of rock feature labels include a mineral composition label, a weathering degree label, and a micro-structural feature label; and construct a predetermined CGAN model based on a conditional generative adversarial network and the plurality of rock feature labels.

In some embodiments, the predetermined CGAN model includes a CGAN model generator and a CGAN model discriminator. The CGAN model generator is obtained based on a random vector and the weathering degree label, and is configured to generate a rock mineral crystal model based on the random vector, the plurality of rock feature labels, and a predetermined loss function. The CGAN model discriminator of the predetermined CGAN model is obtained based on the rock mineral crystal model and the weathering degree label, and is configured to discriminate an image generated by the rock mineral crystal model.

In some embodiments, the predetermined loss function is: [symbol]
where L_{adv} represents an adversarial loss of the CGAN, λ¹ represents a weight hyperparameter for a mineral composition loss, L_{mineral-comp} represents the mineral composition loss, λ² represents a weight hyperparameter for a mineral morphology loss, Lₘᵢₙₑᵣₐₗ₋ₛₕₐₚ represents the mineral morphology loss, λ³ represents a weight hyperparameter for a weathering degree loss, L_{weathering-prod} represents the weathering degree loss, λ⁴ represents a weight hyperparameter for a porosity ratio loss, L_{porosity} represents the porosity ratio loss, λ⁵ represents a weight hyperparameter for a structural similarity loss, and L_{SSIM} represents the structural similarity loss.

In some embodiments, the comparison result includes structural similarity, perceptual loss, peak signal-to-noise ratio, and Frechet Inception Distance. The generation module 300 is configured to: compare each of the structural similarity, the perceptual loss, the peak signal-to-noise ratio, and the Frechet Inception Distance with a corresponding threshold, based on a predetermined quantitative evaluation method, to obtain a plurality of comparison results; and verify, based on the plurality of comparison results, whether the weathered Martian rock microscopic image meets a predetermined validity condition, and evaluate the generation quality of the weathered Martian rock microscopic image based on a verification result.

It should be noted that, the above explanation of the embodiments of the method for generating the image of the weathered Martian rock is also applicable to the apparatus for generating the weathered Martian rock image of the embodiment, and thus details thereof will be omitted here.

With the apparatus for generating the image of the weathered Martian rock according to the embodiments of the present disclosure, the weathered Martian rock sample is obtained. The Martian rock dataset is generated. The knowledge of the predetermined CGAN model is transferred to the Martian rock dataset to obtain the transfer-optimized Martian rock dataset. The weathered Martian rock microscopic image is generated, and compared with the weathered Martian rock sample. The generation quality of the weathered Martian rock microscopic image is evaluated based on the comparison result. Thus, through transfer learning from the terrestrial weathered rock database, the conditional generative adversarial network is constructed to generate the weathered Martian rock microscopic image, which solves the problems in the related art such as the significant limitation in characterizing the Martian rock property, and provides the technical support for the landing site selection, the drilling strategy formulation, and the in-situ resource utilization for the Mars probes.

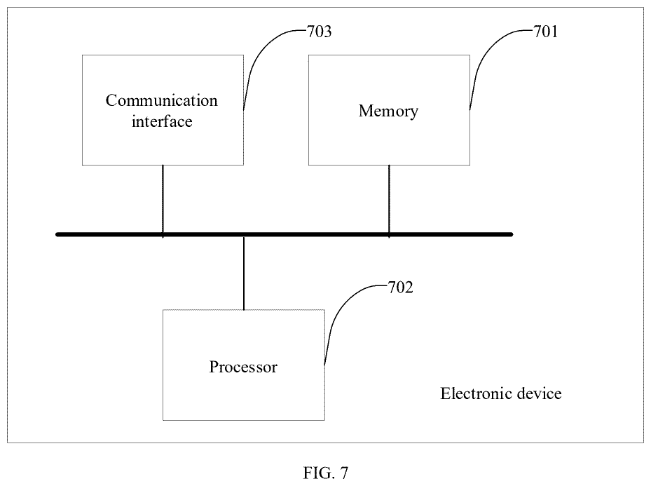

FIG. 7 is a schematic diagram of a structure of an electronic device according to an embodiment of the present disclosure. The electronic device may include a memory 701, a processor 702, and a computer program stored in the memory 701 and executable on the processor 702. The processor 702, when executing the computer program, implements the method for generating the image of the weathered Martian rock according to any of the above embodiments.

Further, the electronic device includes: a communication interface 703 configured for communication between the memory 701 and the processor 702; and the memory 701 configured to store a computer program executable on the processor 702. The memory 701 may include a high-speed Random Access Memory (RAM), and may also include a non-volatile memory, such as at least one disk memory.

When the memory 701, the processor 702, and the communication interface 703 are implemented independently, the communication interface 703, the memory 701, and the processor 702 may be interconnected and communicate with each other via a bus. The bus may be an Industry Standard Architecture (ISA) bus, a Peripheral Component Interconnect (PCI) bus, or an Extended Industry Standard Architecture (EISA) bus. The bus may include an address bus, a data bus, a control bus, etc. For the convenience of description, only one thick line is used in FIG. 7, but it does not mean that there is only one bus or one type of bus.

In an embodiment, when the memory 701, the processor 702, and the communication interface 703 are integrated on a single chip for an implementation, the memory 701, the processor 702, and the communication interface 703 may communicate with each other through an internal interface.

The processor 702 may be a Central Processing Unit (CPU), an Application Specific Integrated Circuit (ASIC), or one or more integrated circuits configured to implement an embodiment of the present disclosure.

A computer-readable storage medium is further provided according to an embodiment of the present disclosure. The computer-readable storage medium stores a computer program. The computer program, when executed by a processor, implements the method for generating the image of the weathered Martian rock as described above.

In the description of this specification, descriptions with reference to the terms “an embodiment”, “some embodiments”, “examples”, “specific examples”, or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or N embodiments or examples in a suitable manner. In addition, those skilled in the art can combine the different embodiments or examples and the features of the different embodiments or examples described in this specification without contradicting each other.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “N” means at least two, such as two, three, etc., unless otherwise specifically defined.

Any process or method described in a flowchart or described herein in other ways may be understood to include one or N modules, segments, or portions of codes of executable instructions for achieving specific logical functions or steps in the process. The scope of a preferred embodiment of the present disclosure includes other implementations. A function may be performed not in a sequence shown or discussed, including a substantially simultaneous manner or a reverse sequence based on the function involved, which should be understood by those skilled in the art to which the embodiments of the present disclosure belong.

It should be understood that each part of the present disclosure may be realized by hardware, software, firmware, or a combination thereof. In the above embodiments, N steps or methods may be realized by software or firmware stored in the memory and executed by an appropriate instruction execution system. For example, when it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a Programmable Gate Array (PGA), a Field Programmable Gate Array (FPGA), etc.

It should be understood by those skilled in the art that all or a part of the steps carried by the method according to the above embodiments may be completed by relevant hardware instructed by a program. The program may be stored in a computer-readable storage medium. When the program is executed, one or a combination of the steps of the method according to the above embodiments may be included.

What is claimed is:

1. A method for generating an image of a weathered Martian rock, the method comprising:
obtaining a weathered Martian rock sample;
generating a Martian rock dataset based on the weathered Martian rock sample, and transferring knowledge of a predetermined Conditional Generative Adversarial Network (CGAN) model to the Martian rock dataset to obtain a transfer-optimized Martian rock dataset; and
generating a weathered Martian rock microscopic image based on the transfer-optimized Martian rock dataset, comparing the weathered Martian rock microscopic image with the weathered Martian rock sample, and evaluating a generation quality of the weathered Martian rock microscopic image based on a comparison result.

2. The method according to claim 1, further comprising, prior to said obtaining the weathered Martian rock sample:
obtaining a plurality of types of terrestrial rock samples;
performing a micro-scale test and a macro-scale test on the plurality of types of terrestrial rock samples to obtain a micro-parameter and a macro-parameter of the plurality of types of terrestrial rock samples, respectively, and performing a standardization processing on the micro-parameter and the macro-parameter to obtain a processed micro-parameter and a processed macro-parameter; and
establishing a multi-scale database of terrestrial weathered rocks based on the processed micro-parameter and a macro-physical-mechanical parameter.

3. The method according to claim 2, further comprising, prior to said obtaining the weathered Martian rock sample:
generating a plurality of rock feature labels for the plurality of types of terrestrial rock samples based on the plurality of types of terrestrial rock samples, wherein the plurality of rock feature labels comprise a mineral composition label, a weathering degree label, and a micro-structural feature label; and
constructing a predetermined CGAN model based on a conditional generative adversarial network and the plurality of rock feature labels.

4. The method according to claim 3, wherein the predetermined CGAN model comprises a CGAN model generator and a CGAN model discriminator, wherein:
the CGAN model generator is obtained based on a random vector and the weathering degree label, and is configured to generate a rock mineral crystal model based on the random vector, the plurality of rock feature labels, and a predetermined loss function; and
the CGAN model discriminator is obtained based on the rock mineral crystal model and the weathering degree label, and is configured to discriminate an image generated by the rock mineral crystal model.

5. The method according to claim 4, wherein the predetermined loss function is: [symbol]
where L_{adv} represents an adversarial loss of the CGAN, λ₁ represents a weight hyperparameter for a mineral composition loss, L_{mineral-comp} represents the mineral composition loss, λ₂ represents a weight hyperparameter for a mineral morphology loss, Lₘᵢₙₑᵣₐₗ₋ₛₕₐₚ represents the mineral morphology loss, λ₃ represents a weight hyperparameter for a weathering degree loss, L_{weathering-prod} represents the weathering degree loss, λ₄ represents a weight hyperparameter for a porosity ratio loss, L_{porosity} represents the porosity ratio loss, λ₅ represents a weight hyperparameter for a structural similarity loss, and L_{SSIM} represents the structural similarity loss.

6. The method according to claim 1, wherein the comparison result comprises structural similarity, perceptual loss, peak signal-to-noise ratio, and Frechet Inception Distance, and wherein said evaluating the generation quality of the weathered Martian rock microscopic image based on the comparison result comprises:
comparing each of the structural similarity, the perceptual loss, the peak signal-to-noise ratio, and the Frechet Inception Distance with a corresponding threshold based on a predetermined quantitative evaluation method, to obtain a plurality of comparison results; and
verifying, based on the plurality of comparison results, whether the weathered Martian rock microscopic image meets a predetermined validity condition, and evaluating the generation quality of the weathered Martian rock microscopic image based on a verification result.

7. An electronic device, comprising:
a memory;
a processor; and
a computer program stored on the memory and executable on the processor, wherein the processor is configured to execute the computer program to implement a method for generating an image of a weathered Martian rock, the method comprising:
obtaining a weathered Martian rock sample;
generating a Martian rock dataset based on the weathered Martian rock sample, and transferring knowledge of a predetermined Conditional Generative Adversarial Network (CGAN) model to the Martian rock dataset to obtain a transfer-optimized Martian rock dataset; and
generating a weathered Martian rock microscopic image based on the transfer-optimized Martian rock dataset, comparing the weathered Martian rock microscopic image with the weathered Martian rock sample, and evaluating a generation quality of the weathered Martian rock microscopic image based on a comparison result.

8. The electronic device according to claim 7, wherein the method further comprises, prior to said obtaining the weathered Martian rock sample:
obtaining a plurality of types of terrestrial rock samples;
performing a micro-scale test and a macro-scale test on the plurality of types of terrestrial rock samples to obtain a micro-parameter and a macro-parameter of the plurality of types of terrestrial rock samples, respectively, and performing a standardization processing on the micro-parameter and the macro-parameter to obtain a processed micro-parameter and a processed macro-parameter; and
establishing a multi-scale database of terrestrial weathered rocks based on the processed micro-parameter and a macro-physical-mechanical parameter.

9. The electronic device according to claim 8, wherein the method further comprises, prior to said obtaining the weathered Martian rock sample:
generating a plurality of rock feature labels for the plurality of types of terrestrial rock samples based on the plurality of types of terrestrial rock samples, wherein the plurality of rock feature labels comprise a mineral composition label, a weathering degree label, and a micro-structural feature label; and
constructing a predetermined CGAN model based on a conditional generative adversarial network and the plurality of rock feature labels.

10. The electronic device according to claim 9, wherein the predetermined CGAN model comprises a CGAN model generator and a CGAN model discriminator, wherein:
the CGAN model generator is obtained based on a random vector and the weathering degree label, and is configured to generate a rock mineral crystal model based on the random vector, the plurality of rock feature labels, and a predetermined loss function; and
the CGAN model discriminator is obtained based on the rock mineral crystal model and the weathering degree label, and is configured to discriminate an image generated by the rock mineral crystal model.

11. The electronic device according to claim 10, wherein the predetermined loss function is: [symbol]
where L_{adv} represents an adversarial loss of the CGAN, λ₁ represents a weight hyperparameter for a mineral composition loss, L_{mineral-comp} represents the mineral composition loss, λ₂ represents a weight hyperparameter for a mineral morphology loss, Lₘᵢₙₑᵣₐₗ₋ₛₕₐₚ represents the mineral morphology loss, λ₃ represents a weight hyperparameter for a weathering degree loss, L_{weathering-prod} represents the weathering degree loss, λ₄ represents a weight hyperparameter for a porosity ratio loss, L_{porosity} represents the porosity ratio loss, λ₅ represents a weight hyperparameter for a structural similarity loss, and L_{SSIM} represents the structural similarity loss.

12. The electronic device according to claim 7, wherein the comparison result comprises structural similarity, perceptual loss, peak signal-to-noise ratio, and Frechet Inception Distance, and wherein said evaluating the generation quality of the weathered Martian rock microscopic image based on the comparison result comprises:
comparing each of the structural similarity, the perceptual loss, the peak signal-to-noise ratio, and the Frechet Inception Distance with a corresponding threshold based on a predetermined quantitative evaluation method, to obtain a plurality of comparison results; and
verifying, based on the plurality of comparison results, whether the weathered Martian rock microscopic image meets a predetermined validity condition, and evaluating the generation quality of the weathered Martian rock microscopic image based on a verification result.

13. A non-transitory computer-readable storage medium, having a computer program stored thereon, wherein the computer program is executed by a processor to implement a method for generating an image of a weathered Martian rock, the method comprising:
obtaining a weathered Martian rock sample;
generating a Martian rock dataset based on the weathered Martian rock sample, and transferring knowledge of a predetermined Conditional Generative Adversarial Network (CGAN) model to the Martian rock dataset to obtain a transfer-optimized Martian rock dataset; and
generating a weathered Martian rock microscopic image based on the transfer-optimized Martian rock dataset, comparing the weathered Martian rock microscopic image with the weathered Martian rock sample, and evaluating a generation quality of the weathered Martian rock microscopic image based on a comparison result.
